(19) United States
(12) Patent Application Publication
(10) Pub. No.: US 2021/0191605 A1
(43) Pub. Date: Jun. 24, 2021

(54) METHOD FOR DISPLAYING WEB BROWSER AND TERMINAL DEVICE USING THE SAME

(71) Applicant: NAVER CORPORATION, Seongnam-si (KR)

(72) Inventors: Hanno LEE, Seongnam-si (KR); Byungsoo KIM, Seongnam-si (KR); Yeongje KIM, Seongnam-si (KR); Jihyun HWANG, Seongnam-si (KR); Jung Hee BAEK, Seongnam-si (KR); Jinah PARK, Seongnam-si (KR); Eunbi JOE, Seongnam-si (KR); Hyoung Jung KIM, Seongnam-si (KR)

(21) Appl. No.: 17/123,348

(22) Filed: Dec. 16, 2020

(30) Foreign Application Priority Data
Dec. 20, 2019 (KR) 10-2019-0171942

(51) Int. Cl. G06F 3/0484; G06F 40/106; G06T 3/40; G06F 40/14; G06F 3/0488; G06F 3/0485

(52) U.S. Cl. CPC G06F 3/04845; G06F 40/106; G06T 3/40; G06T 2200/24; G06F 3/04883; G06F 3/0485; G06F 40/14

(57) ABSTRACT

A method for displaying a web browser of a terminal device having a first display area and a second display area includes displaying web contents in the first display area by executing the web browser; receiving an enlargement request for the web contents from a user; and enlarging and displaying the web contents in the second display area in response to the enlargement request.

### CROSS-REFERENCE TO RELATED APPLICATIONS

This application claims priority of Korean Patent Application No. 10-2019-0171942 filed on Dec. 20, 2019 in the Korean Intellectual Property Office, the entire contents of which are hereby incorporated by reference in their entirety.

### BACKGROUND OF THE INVENTION

### Field of Invention

The present invention relates to a method for displaying a web browser and a terminal device using the same, and particularly, to a method for displaying web content, which is capable of providing an enlarged view function by using a plurality of display areas, and a terminal device using the same.

### Description of Related Art

In recent years, with the rapid development of computer, electronic, and Internet communication technologies, various multimedia communication services have been provided using a wireless communication network. Accordingly, mobile terminals such as smart phones that support users to fully utilize multimedia communication services have been in the spotlight, and various contents such as applications for mobile terminals are also being developed and released.

Among various applications for the mobile terminals, in particular, various web browsers for assisting users of the mobile terminal to use the Internet may display web pages loaded from a web server and including contents on a display of the mobile terminal. The user can view the web page through the web browser and continuously browse other web pages or browse a new web page.

Also in recent years, a mobile device with a dual display or a foldable mobile device in which two screens can be used by virtually dividing one display into two areas has been provided and a web browser using the same has also been developed.

### BRIEF SUMMARY OF THE INVENTION

The present invention has been made in an effort to provide a method for displaying a web browser capable of providing an enlarged view function by using a plurality of display areas and a terminal device using the same.

The present invention has been made in an effort to provide a method for displaying a web browser capable of displaying a position and a size of an enlarged enlargement target area among all web contents in a first display area and providing the enlarged web contents to a second display area by using an advantage of including a plurality of display areas, and a terminal device using the same.

An exemplary embodiment of the present invention provides a method for displaying a web browser of a terminal device including a first display area and a second display area. The method may include: displaying web contents in the first display area by executing the web browser; receiving an enlargement request for the web contents from a user; and enlarging and displaying the web contents in the second display area in response to the enlargement request.

Another exemplary embodiment of the present invention provides a method for displaying contents of a terminal device including a first display area and a second display area. The method may include: receiving an enlargement request for contents being displayed in the first display area from a user; and enlarging and displaying the web contents being displayed in the first display area in the second display area in response to the enlargement request.

Still another exemplary embodiment of the present invention provides a terminal device which may include: a display unit including a first display area and a second display area; a touch panel unit positioned to correspond to the first display area and the second display area, and detecting a touch input applied by a user; and a control unit displaying web contents in the first display area by executing a web browser, and controlling to enlarge and display the web contents in the second display area when receiving an enlargement request for the web contents from the user.

The technical solution above does not list all features of the present invention. Various features of the present invention and advantages and effects according thereto will be understood in more detail with reference to specific embodiments below.

According to an exemplary embodiment of the present invention, a method for displaying a web browser and a terminal device using the same can provide an enlarged view function using a dual display area. That is, even when texts or images in web contents need to be enlarged, a user can easily check contents of the web contents without repeated scrolling or enlargement or reduction of the web contents.

According to an exemplary embodiment of the present invention, by a method for displaying a web browser and a terminal device using the same, a position and a size of an enlarged enlargement target area among web contents are displayed in a first display area and the enlarged web contents are provided to a second display area. Accordingly, the user can conveniently check the enlarged contents of the web contents while changing the position and the size of the enlargement target area.

According to an exemplary embodiment of the present invention, by a method for displaying a web browser and a terminal device using the same, it is possible to specify an area touched by the user as the enlargement target area, and enlarge and display the specified enlargement target area. That is, the user can intuitively specify an area to be enlarged, and thereby widen the enlargement target area by a simple method of extending a touch area, thereby enhancing convenience of the user.

However, effects which can be obtained by the method for displaying a web browser and the terminal device using the same according to the exemplary embodiments of the present invention are not limited to the aforementioned advantages and other unmentioned advantages will be clearly understood by those skilled in the art from the following description.

### BRIEF DESCRIPTION OF THE DRAWINGS

FIG. 1 is a schematic diagram illustrating a web browsing system according to an exemplary embodiment of the present invention.

FIG. 2 is a block diagram illustrating a terminal device according to an exemplary embodiment of the present invention.

FIG. 3 is an illustration of web contents being displayed on a terminal device according to an exemplary embodiment of the present invention.

FIGS. 4 and 5 are illustrations of an enlarged view of web contents generated by a terminal device according to an exemplary embodiment of the present invention.

FIG. 6 is an illustration of an enlarged view of an area generated by a terminal device according to an exemplary embodiment of the present invention.

FIGS. 7A-7B and 8 are are illustrations of an enlarged view of web contents generated by a terminal device according to another exemplary embodiment of the present invention.

FIG. 9 is a flowchart showing a method for displaying web contents on a terminal device according to an exemplary embodiment of the present invention.

### DETAILED DESCRIPTION OF THE INVENTION

Hereinafter, exemplary embodiments disclosed in the present disclosure will be described in detail with reference to the accompanying drawings, and the same or similar components are denoted by the same reference numerals regardless of the views of the drawings, and duplicated description thereof will be omitted. The term “unit” used in the specification means software or hardware components such as FPGA or ASIC, and the “unit” performs predetermined roles. However, the “unit” is not a meaning limited to software or hardware. The “unit” may be configured to reside on an addressable storage medium and may be configured to for executing various functions of one or more processors. Accordingly, as one example, the “unit” includes components such as software components, object oriented software components, class components, and task components, processes, functions, attributes, procedures, subroutines, segments of a program code, drivers, firmware, microcodes, circuitry, data, databases, data structures, tables, arrays, and variables. Functions provided in the components and the “units” may be combined into a smaller number of components and “units” or further separated into additional components and “units”.

In describing the exemplary embodiment of the present disclosure, a detailed description of related known technologies will be omitted if it is determined that the detailed description makes the gist of the exemplary embodiment disclosed in the present disclosure unclear. Further, it is to be understood that the accompanying drawings are used for easily understanding the exemplary embodiments disclosed in the present disclosure and a technical spirit disclosed in the present disclosure is not limited by the accompanying drawings and all changes, equivalents, or substitutes included in the spirit and the technical scope of the present disclosure are included.

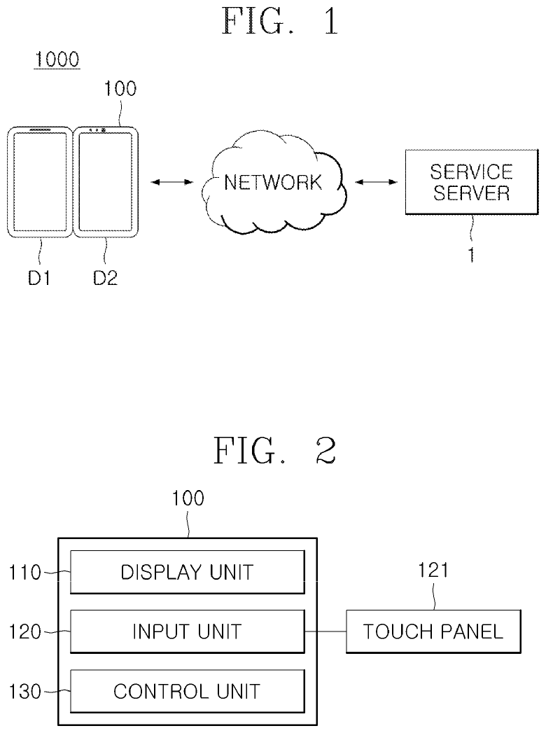

FIG. 1 is a schematic diagram illustrating a web browsing system according to an exemplary embodiment of the present invention.

Referring to FIG. 1, a web browsing system 1000 according to an exemplary embodiment of the present invention may include a terminal device 100 and a service server 1.

The terminal device 100 may execute various types of applications and display the applications being executed visually or auditorily and provide the applications to a user. The terminal device 100 may include a display unit for visually displaying the application and may include an input unit receiving an input of the user, a communication unit, a memory storing at least one program, and a processor.

The terminal device 100 may be a mobile terminal such as a smart phone, a tablet PC, etc., and may also include a fixed device such as a desktop, etc., in some exemplary embodiments. Specifically, the terminal device 100 may include a cellular phone, a smart phone, a laptop computer, a digital broadcasting terminal, a personal digital assistants (PDA), a portable multimedia player (PMP), a slate PC, a tablet PC, an ultrabook, a wearable device (e.g., a watch type terminal (smartwatch), a glass type terminal (smart glass), or a head mounted display (HMD)), etc.

The terminal device 100 may access an App store or a Play store to download and install various applications including a web browser, etc. In some exemplary embodiments, it is possible to download various applications through wired or wireless communications with a service server or other devices (not illustrated).

The terminal device 100 may be connected with the service server 1 through a network. The network may include a wired network and a wireless network and, in detail, may include various networks including a local area network (LAN), a metropolitan area network (MAN), a wide area network (WAN), and the like. Further, the network may include the known world wide web (WWW). However, the network according to an exemplary embodiment of the present invention is not limited to the enumerated networks and may include a known wireless data network, a known telephone network, and a known wired/wireless television network.

The terminal device 100 may execute a web browser and load web pages onto the web browser according to the input of the user. In this case, the terminal device 100 may request web contents including web pages, web documents, etc., from the service server 1 and display the web contents provided from the service server 1 through the web browser. That is, the terminal device 100 may output the web contents provided from the service server 1 through the display unit mounted on the terminal device 1 and provide the web contents to the user.

The service server 1 may be connected to the terminal device 100 through an application such as the web browser executed by the terminal device 100 and provide various online services in response to the request of the terminal device 100. The service server 1 may store the web contents which may be provided to the terminal device 100 and transmit the web contents to the terminal device 100 according to the request of the terminal device 100.

When a web document is viewed on a conventional terminal device, there may be cases in which the letters in the web document are too small to read, and since a conventional terminal device includes only one display unit, the user may view the contents by enlarging the corresponding web document by using an enlargement function provided by the terminal device or the web browser.

However, when the web document is enlarged, a horizontal or vertical scroll may occur in a display screen, and there is inconvenience that the size of the web document must be reduced again in order to view the contents of the entire web document at a glance without scrolling. Further, when the text of the web document is read and a line break occurs in an enlarged state of the web document, the user must repeatedly perform scrolling or reduce the size of the web document, to move to a sentence on a lower left end of the web document again.

In contrast, since the terminal device 100 according to an exemplary embodiment of the present invention includes a dual display, it is possible to display the web document in a first display area D1 and enlarge and display the the same web document in a second display area D2. That is, the user may easily check the web document without repeated scrolling or enlargement or reduction of the web document.

Hereinafter, the terminal device 100 according to an exemplary embodiment of the present invention will be described.

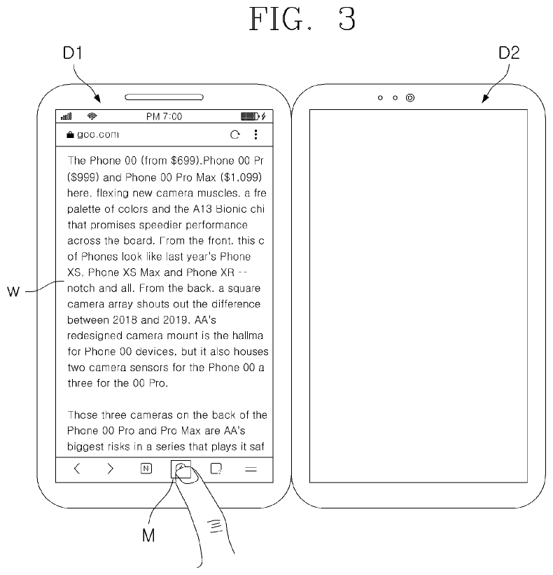

FIG. 2 is a block diagram illustrating a terminal device 100 according to an exemplary embodiment of the present invention.

Referring to FIG. 2, the terminal device 100 according to an exemplary embodiment of the present invention may include a display unit 110, an input unit 120, and a control unit 130.

The display unit 110 may display the web browser output by the terminal device 100 and visually provide the web browser to the user. Here, the display unit 110 may include the first display area D1 and the second display area D2, and display web contents such as respective web pages, web documents, etc., separately in the first display area D1 and the second display area D2.

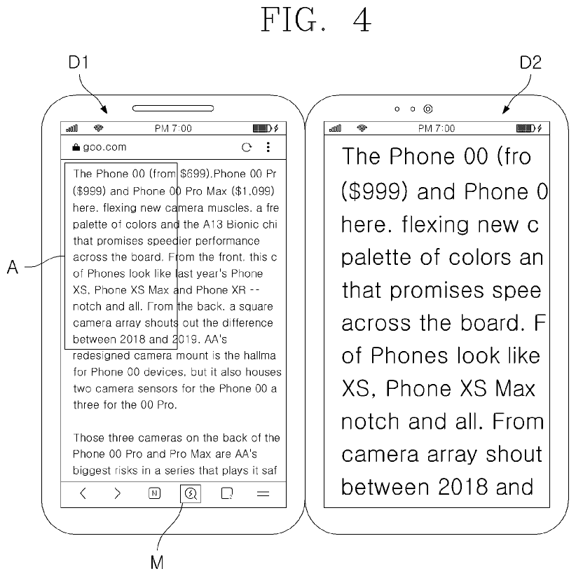

Here, as illustrated in FIG. 3, the first display area D1 and the second display area D2 may have the same size and aspect ratio, and the first display area D1 and the second display area D2 may be implemented as separate display devices that are physically separated. However, in some exemplary embodiments, an area in one display device is virtually divided to be separated into the first display area D1 and the second display area D2. Further, in some exemplary embodiments, the display unit 110 may be implemented as a foldable display which is folded with the first display area D1 and the second display area D2 to face each other.

The input unit 120 may receive various inputs of the user. Here, the input unit 120 may include a touch panel, a pen sensor, a pressure sensor, a key, a microphone, and the like. In some exemplary embodiments, a touch panel 121 may be implemented as a separate component in communication with the input unit 120 as depicted in FIG. 2. The touch panel 121 may sense a touch input of the user, and may be of a capacitive type, a pressure sensitive type, an infrared type, or an ultrasonic type. A pen sensor (not shown) may be a part of the touch panel or may further include a separate recognition sheet, and the key may include a physical button, an optical key, or a keypad. A microphone (not shown) is a configuration for receiving a user's voice and may be provided inside the terminal device 100, but in some exemplary embodiments, the microphone may be provided outside the terminal device 100 to be electrically connected to the terminal device 100.

Specifically, the touch panel 121 may be positioned to correspond to the first display area D1 and the second display area D2, and may detect the touch input applied by the user. That is, the user may execute the web browser and apply touch inputs for searching for a web page or web document desired by the user within the web browser. In this case, various touch inputs of the user applied into the first display area D1 and the second display area D2 may be recognized using the touch panel 121, and the recognized touch inputs may be transmitted to the control unit 130.

The control unit 130 may include a memory and a processor and may generally control the operation of the terminal device 100. Here, the control unit 130 may load a web browser program into the memory according to the input of the user and execute the web browser program through the processor. The web browser may be optimized to correspond to the display unit 110 having a plurality of display areas, and the control unit 130 may perform an enlarged view function to enlarge and display the web contents such as the web document being displayed in the first display area D1 in the second display area D2.

Specifically, the control unit 130 executes the web browser to display the web contents in the first display area D1. Here, when it is difficult to visually view the text or image included in the web contents due to the small size of the text or image, the user may input an enlargement request for the corresponding web contents. In this case, the control unit 130 may enlarge and display the web contents in the second display area D2 in response to the enlargement request.

Here, an enlargement request may be a touch input of the user for an enlargement icon M displayed in the web browser, as illustrated in FIG. 3. That is, when the user applies the touch input to the enlargement icon M, the control unit 130 may enlarge and display some of web contents W being displayed in the first display area D1 into the second display area D2.

Alternatively, a gesture operation of the user for the enlarged view function in the web browser may be preset, and a gesture input which the user performs on the terminal device 100 may be detected to perform an enlarged view for the corresponding web contents W. For example, a gesture such as an operation of covering and releasing the first display area D1 of the terminal device 100 with a palm, an operation of lowering the palm from the top to the bottom of the first display area D1, or an operation of swiping the palm from the left to the right of the first display area D1 may be detected, and the enlarged view function may be preset to be executed in response to the corresponding gesture. Here, the gesture input by the user for the enlargement view may be variously set in some exemplary embodiments.

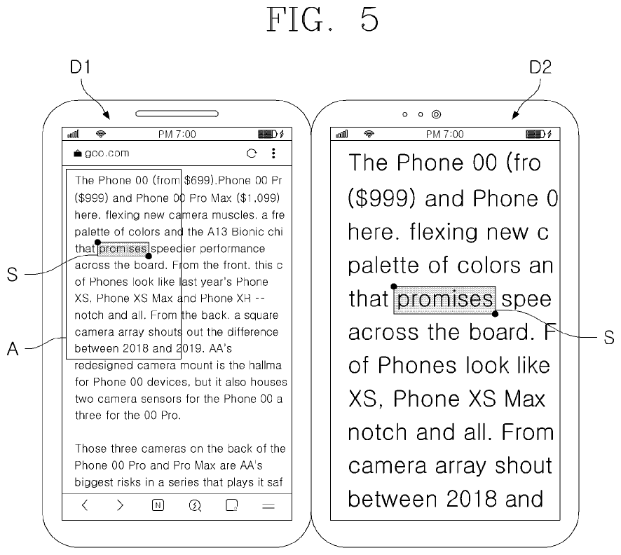

When the enlargement view is executed, the control unit 130 may display an enlargement target area A in the first display area D1 and the enlargement target area A may be enlarged and displayed in the second display area D2 as illustrated in FIG. 4. Here, the enlargement target area A may be enlarged to be displayed in an entire area of the second display area D2. That is, the control unit 130 may display the enlargement target area A to be full in the second display area D2 by adjusting the scale factor of the enlargement target area A.

In the case the user intends to change the location of the enlargement target area A, the control unit 130 may change the location of the enlargement target area A by detecting a touch input of the user on the enlargement target area A. For example, the user may move the location of the enlargement target area A by a method of dragging the enlargement target area A in a desired direction. In this case, the web contents W included in the moved enlargement target area A may be enlarged and displayed in the second display area D2 in response to the position movement of the enlargement target area A.

When a user intends to change the size of the enlargement target area A, the control unit 130 may change the size of the enlargement target area A by detecting the touch input of the user on the enlargement target area A. For example, the user may pinch in the enlargement target area to reduce the size of the enlargement target area A and pinch out the enlargement target area to increase the size of the enlargement target area A. Here, an enlargement or reduction input for the enlargement target area A may be set by various other methods besides the pinch-in or pinch-out method.

In this case, the enlargement target area A may have a fixed ratio which corresponds to the aspect ratio (for example, 16:9, 18:9) of the first display area D1. When the size of the enlargement target area A is changed, the control unit 130 may enlarge or reduce the enlargement target area A according to the fixed ratio. However, in some exemplary embodiments, it is also possible to change the aspect ratio of the enlargement target area A according to the input of the user. For example, the user may select any one of the vertices of the enlargement target area A being displayed in the first display area D1, and then adjust the fixed ratio of the enlargement target area A by a method of dragging the selected vertex. Thereafter, when the user applies the enlargement or reduction input for the enlargement target area A, the control unit 130 may change the size of the enlargement target area A according to the changed fixed ratio.

Additionally, the user may apply the enlargement or reduction input in the second display area D2 and in this case, the control unit 130 may change the scale factor of the second display area D2 in response to the corresponding enlargement or reduction input. In this case, the control unit 130 may also change the size of the enlargement target area A displayed in the first display area D1 together in response to the change of the scale factor of the second display area D2. For example, when the second display area D2 is enlarged, the size of the enlargement target area A displayed in the first display area D1 may be reduced and when the second display area D2 is reduced, the size of the enlargement target area A may be enlarged.

When the user applies the scroll input to the second display area D2, the control unit 130 may move the enlargement target area A in the first display area D1. That is, the enlargement target area A may be moved in the first display area D1 in a scroll direction input by the user in the second display area D2. Since the enlargement target area A and the second display area D2 correspond to each other, when the position movement or the enlargement or reduction input for each area is applied, the location movement or the enlargement or reduction may be performed so that the enlargement target area A and the second display area D2 correspond to each other.

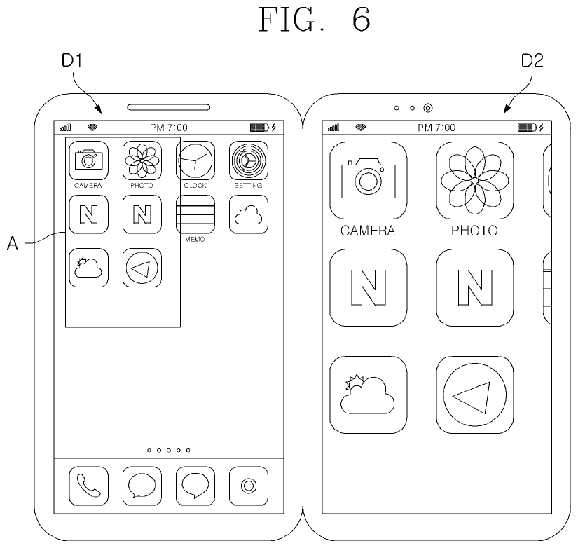

When an interaction of the user, etc., is performed within one of the enlarged target area A or the second display area D2, the control unit 130 may display the corresponding interaction to be reflected similarly to the other of the enlargement target area A or the second display area D2. As illustrated in FIG. 5, when the user selects a partial area in the second display area D2, the selected area S may be highlighted. Here, the user has selected the partial area in the second display area D2 only, but it can be seen that the partial area at the same location in the enlargement target area A is highlighted also. As such, the interaction may be reflected similarly to the enlargement target area A and the second display area D2. Even when the user performs an interaction of inputting an object such as a text or an image, an emoticon, a memo, etc., into the enlargement target area A or the second display area D2, the control unit 130 may display the corresponding interaction similarly at the corresponding locations of the other display area.

In some exemplary embodiments, the control unit 130 may move the enlargement target area A according to the touch input of the user and in this case, there may be a case where the enlargement target area A reaches an edge of the first display area D1. In this case, the control unit 130 may scroll and move the first display area D1 in a direction in which the enlargement target area A reaches the edge. However, this may be performed only when it is possible to scroll the web contents W displayed in the first display area D1 and when it is impossible to scroll the web contents W, an additional scroll may not be performed. In this case, the control unit 130 may output a haptic or a visual effect indicating that the scroll is impossible.

When the user applies the enlargement or reduction input outside the enlargement target area A in the first display area D1, the control unit 130 may enlarge or reduce the web contents W in the first display area D1. In this case, the size of the enlargement target area A is maintained to be the same in spite of the enlargement or reduction of the web contents W or may be increased or reduced at the same ratio according to the enlargement or reduction of the web contents. Here, when the size of the enlargement target area A is maintained to be the same, the range of the web contents W included in the enlargement target area A may be changed according to the enlargement or reduction of the web contents W. Accordingly, the range of the web contents displayed in the second display area D2 may also be changed and displayed. On the contrary, when the size of the enlargement target area A is enlarged or reduced similarly with the enlargement or reduction of the web contents W, the web contents W displayed in the second display area D2 may be maintained to be the same. Here, the user may arbitrarily set whether the enlargement target area A is enlarged or reduced together with the web contents W.

When the user applies the enlargement or reduction input within the enlargement target area A, the size of the enlargement target area A may be enlarged or reduced. In this case, since the range of the web contents W included in the enlargement target area A is changed, the web contents displayed in the second display area D2 may also be enlarged or reduced.

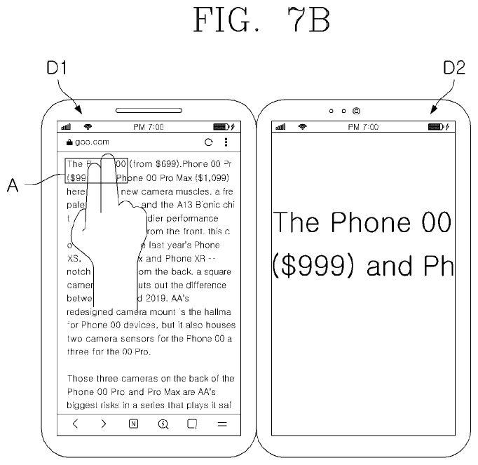

Additionally, in some exemplary embodiments, it is also possible to specify the enlargement target area A as an area which the user touches in the first display area D1. That is, as illustrated in FIGS. 7A and 7B, the control unit 130 may specify the enlargement target area A in response to the location and an area of the touch input applied into the first display area D1 by the user. The specified enlargement target area A may be enlarged and displayed in the second display area D2 as illustrated in FIGS. 7A and 7B. Here, as illustrated in FIG. 7A, when the first display area D1 is touched with one finger, an area touched with one finger may be specified as the enlargement target area A, and the corresponding enlargement target area A may be enlarged and displayed in the second display area D2.

In contrast, as illustrated in FIG. 7B, when the first display area D1 is touched with two fingers, an area touched with two fingers may be specified as the enlargement target area A, and the corresponding enlargement target area A may be enlarged and displayed in the second display area D2.

That is, the user may intuitively specify an area to be enlarged thereby and widen the enlargement target area by a simple method of extending a touch area, thereby enhancing convenience of the user.

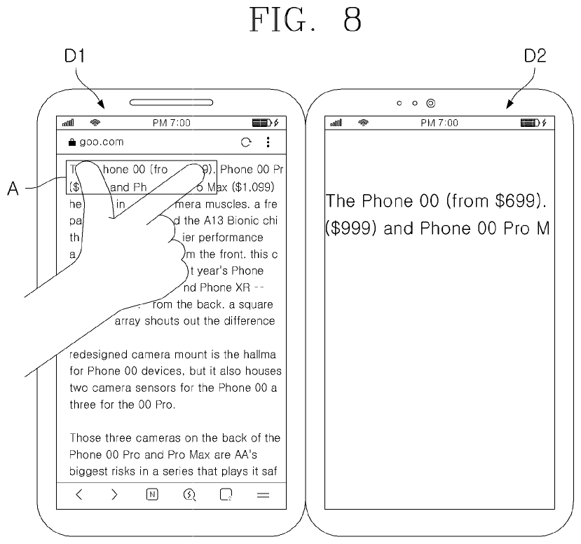

However, since there is a limit to increasing the touch area of the user, in some exemplary embodiments, it is possible for the control unit 130 to recognize an area between a plurality of touch inputs and specify the recognized area as the enlargement target area A. That is, as illustrated in FIG. 8, when the plurality of touch inputs is simultaneously input into the first display area D1, at least two touch inputs among the plurality of touch inputs may be selected and an area between the selected touch inputs may be specified as the enlargement target area A. In this case, since a space between the separated touch inputs may be specified as the enlargement target area A, it is possible to easily expand the enlargement target area A.

In some exemplary embodiments, a plurality of fingers may be separated from each other to touch the first display area D1, and in this case, the control unit 130 may specify a gap between two touch inputs which are most distant from each other and set the specified gap as the enlargement target area A. Alternatively, two touch inputs which are positioned in a horizontal relationship may be selected among the plurality of touch inputs and specified as the enlargement target area A, or a polygon connecting the plurality of touch inputs may be formed, and then a polygonal area may be specified as the enlargement target area A.

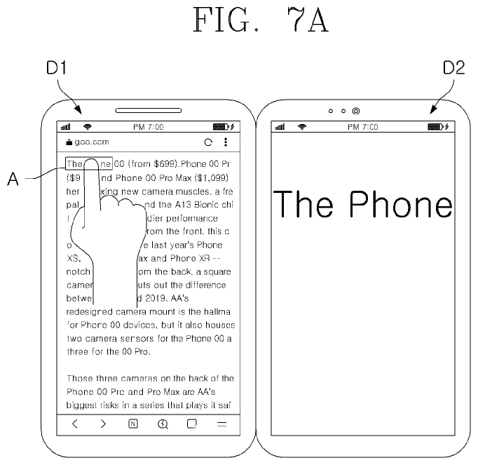

The terminal device 100 according to an exemplary embodiment of the present invention is capable of providing an enlarged view function in an operating system of the terminal device. That is, the present invention is not limited to the type of application such as a web browser, and all contents displayed in the first display area D1 of the terminal device 100 may be enlarged and displayed in the second display area D2. In this case, the user may apply the enlargement request to the terminal device 100 and the terminal device may enlarge and display the contents being displayed in the first display area D1, in the second display area D2 in response to the enlargement request of the user. Accordingly, as illustrated in FIG. 6, an exemplary embodiment is possible, such as enlarging and displaying a part of a home screen of the terminal device in the second display area. In accordance with an embodiment of the invention, the user may provide the enlarged view function even for a document or an image downloaded into the terminal device 100.

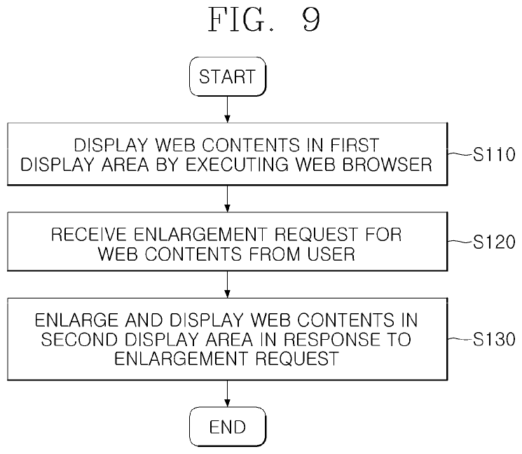

FIG. 9 is a flowchart showing a method for displaying a web browser of the terminal device 100 according to an exemplary embodiment of the present invention.

Referring to FIG. 9, the terminal device 100 executes a web browser to display web contents in a first display area D1 (S110). Here, each of the first and second display areas D1 and D2 may have the same size and aspect ratio. In this case, the web contents may be displayed in the first display area D1 of the terminal device 100, and letters or images in the web contents may be too small and may need to be enlarged.

In this case, the terminal device 100 may receive an enlargement request for the web contents from the user (S120). Here, the enlargement request may include a touch input of the user for an enlargement icon M displayed in the web browser, or a gesture input of the user on the first display area D1 corresponding to the enlargement request.

Upon receiving the enlargement request from the user, the terminal device 100 may enlarge and display the web contents in the second display area D1 in response to the enlargement request (S130). In this case, the terminal device 100 may display an enlargement target area in the first display area D1, and the enlargement target area may be displayed to include at least a part of the first display area. Thereafter, the terminal device 100 may enlarge and display the enlargement target area in the second display area D2, and at this time, the enlargement target area may be displayed in the entirety of the second display area by adjusting a scale factor of the enlarged target area so that the entire area of the second display area is displayed.

Here, the terminal device 100 may change the location or size of the enlargement target area according to the touch input of the user for the enlargement target area. For example, the location of the enlargement target area may be moved by dragging the enlargement target area, and the size of the enlargement target area may be changed in response to a pinch-in or pinch-out of the enlargement target area.

In this case, the enlargement target area may have a fixed ratio corresponding to the aspect ratio of the first display area, and when the size of the enlargement target area is changed, the enlargement target area may be enlarged or reduced according to the fixed ratio. However, in some exemplary embodiments, it is also possible to change the fixed ratio of the enlargement target area according to the input of the user, and in this case, the enlargement target area may be enlarged or reduced according to the changed fixed ratio.

When the user applies an enlargement or reduction input to the second display area D2, the terminal device 100 may change the scale factor of the second display area and display the second display area. In this case, the terminal device 100 may also change the size of the enlargement target area of the first display area D1 in response to the change of the scale factor. When the user applies a scroll input to the second display area D2, the enlargement target area may be moved within the first display area D1 in the same scroll direction as in the second display area.

Additionally, the user may perform an interaction on the web contents displayed in one of the enlargement target area or the second display area and, in this case, the terminal device 100 may reflect the interaction similarly to the other of the enlargement target area and the second display area D1 and display the web contents. Here, the interaction applied by the user may include inserting an object such as a text or an image, an emoticon, a memo, etc., or highlighting an area selected by the user, etc.

On the other hand, the terminal device 100 may move the enlargement target area according to the touch input of the user, and when the enlargement target area reaches a edge of the first display area D1, the first display area may be scrolled in a direction in which the enlargement target area reaches the edge. Since the first display area D1 scrolls in response to the movement of the enlargement target area, the user may easily notice the area to be enlarged while moving the enlargement target area in the second display area D2.

Moreover, there may be provided a user interface (UI) for enlarging or reducing the web contents in the first display area D1 when the user applies the enlargement or reduction input outside the enlargement target area of the first display area D1 and enlarging or reducing the enlargement target area when the user applies the enlargement or reduction input inside the enlargement target area.

Additionally, the enlargement target area may be specified in response to the location and the area of the touch input which the user applies in the first display area D1. In this case, the specified enlargement target area may be enlarged and displayed in the second display area D2. In addition, there may be a case where a plurality of touch inputs is simultaneously input in the first display area. In this case, at least two touch inputs among the plurality of touch inputs may be selected, and an area between the selected touch inputs may be specified as the enlargement target area.

The present invention described above can be embodied as computer readable codes stored on a recording medium. The computer readable media may continuously store computer executable programs or temporarily store the computer executable programs for execution or download. Further, the media may be various recording means or storage means of a type in which single hardware or several hardware is coupled, and are not limited to a medium directly connected to any computer system and may also be distributed on a network. Examples of the computer readable media may include magnetic media such as hard disks, floppy disks, and magnetic tape, optical recording media such as CD-ROM and DVD, magneto-optical media such as floptical disks, ROM, RAM, and flash memories and may be configured to store program commands. Further, examples of other media may also include recording media or storage media managed in app stores for distributing applications, or sites and servers for supplying and distributing other various software. Accordingly, the aforementioned detailed description should not be construed as restrictive in all terms and should be considered to be exemplary. The scope of the present disclosure should be determined by rational construing of the appended claims and all modifications within an equivalent scope of the present disclosure are included in the scope of the present disclosure.

The present invention is not limited by the aforementioned embodiments and the accompanying drawings. It will be apparent to those skilled in the art that components according to the present invention may be substituted, modified, and changed within the scope without departing from the technical scope of the present invention.

What is claimed is:

1. A method for displaying web contents on a terminal device having a first display area and a second display area, the method comprising:
displaying web contents in the first display area by executing a web browser installed in the terminal device;
receiving an enlargement request for the web contents from a user; and
enlarging and displaying the web contents in the second display area in response to the enlargement request.

2. The method of claim 1, wherein the enlargement request includes a touch input of a user on an enlargement icon displayed in the first display area, or a gesture input of the user on the terminal device corresponding to the enlargement request.

3. The method of claim 1, wherein in the enlarging and displaying of the web contents,
an enlargement target area is located on a portion of the web contents and displayed in the first display area, and the portion of the web contents is enlarged and displayed in the second display area.

4. The method of claim 3, wherein in the enlarging and displaying of the web contents,
the portion of the web contents is displayed in an entire area of the second display area by adjusting a scale factor of the enlargement target area.

5. The method of claim 3, wherein in the enlarging and displaying of the web contents, a location or a size of the enlargement target area is changed according to a touch input of the user for the enlargement target area.

6. The method of claim 5, wherein the enlargement target area has a fixed ratio corresponding to the aspect ratio of the first display area, and when the size of the enlargement target area is changed, the enlargement target area is enlarged or reduced according to the fixed ratio.

7. The method of claim 3, wherein in the enlarging and displaying of the web contents, when the user applies an enlargement or a reduction input to the second display area, a scale factor of the second display area is changed and displayed, and a size of the enlargement target area is changed in response to the change of the scale factor of the second display area.

8. The method of claim 3, wherein in the enlarging and displaying of the web content, when the user applies a scroll input to the second display area, the enlargement target area is moved in a direction of the scroll within the first display area.

9. The method of claim 3, wherein in the enlarging and displaying of the web contents, when an interaction of the user with the web content displayed in one of the enlargement target area or the second display area is performed, the interaction is reflected and displayed identically in the other of the enlargement target area or the second display area.

10. The method of claim 3, wherein in the enlarging and displaying of the web contents, when the enlargement target area is moved according to a touch input of the user and reaches an edge of the first display area, the first display area is scrolled in a direction in which the enlargement target area reaches the edge.

11. The method of claim 3, wherein in the enlarging and displaying of the web contents,
the web content is enlarged or reduced in the first display area when the user applies an enlargement or a reduction input outside the enlargement target area of the first display area, and
the enlargement target area is enlarged or reduced when the user applies the enlargement or reduction input inside the enlargement target area.

12. The method of claim 1, wherein in the enlarging and displaying of the web contents,
the enlargement target area is specified in response to a location and an area of a touch input applied to the first display area by the user, and the enlargement target area is enlarged and displayed in the second display area.

13. The method of claim 12, wherein in the enlarging and displaying of the web contents, when a plurality of touch inputs is simultaneously input in the first display area, at least two touch inputs among the plurality of touch inputs are selected, and an area between the selected touch inputs is specified as the enlargement target area.

14. A non-transitory computer readable recording medium storing a computer program for providing instructions to a computer to execute a method for displaying web contents as described in claim 1.

15. A terminal device comprising:
a display unit including a first display area and a second display area;
a touch panel unit configured to communicate with the first display area and the second display area for detecting a touch input applied by a user; and
a control unit for displaying web content in the first display area by executing a web browser, and enlarging and displaying the web contents in the second display area when receiving an enlargement request for the web contents from the user.
